(19) United States
(12) Patent Application Publication
(10) Pub. No.: US 2020/0249053 A1
(43) Pub. Date: Aug. 6, 2020

(54) TOUCH SENSOR

(71) Applicant: Panasonics Intellectual Property Management Co., Ltd., Osaka (JP)

(72) Inventors: Keishiro MURATA, Kyoto (JP); Masakazu FUKUI, Okayama (JP); Itaru OOTANI, Osaka (JP); Hiromitsu NIWA, Osaka (JP)

(21) Appl. No.: 16/640,241

(22) PCT Filed: Aug. 27, 2018
(86) PCT No.: PCT/JP2018/031467

§ 371 Date: Feb. 19, 2020

(30) Foreign Application Priority Data
Oct. 20, 2017 (JP) 2017-203510

(51) Int. Cl. G01D 5/241; G06F 3/044

(52) U.S. Cl. CPC G01D 5/241; G06F 3/044

(57) ABSTRACT

This touch sensor includes: a substrate having a plurality of edges; a sensor electrode unit disposed on the substrate; and an antistatic electrode unit disposed between the sensor electrode unit and the plurality of edges and including a first needle electrode electrically independent of the sensor electrode unit. A first edge which is one of the plurality of edges is along in the first direction, the first needle electrode is disposed between the first edge and the sensor electrode unit, and the first needle electrode extends toward the first edge.

### TECHNICAL FIELD

The present invention relates to touch sensors mainly used in operation of various electronic devices.

### BACKGROUND ART

More electronic devices of various types include transparent touch sensors on display units (for example, liquid-crystal displays). An operator operates an electronic device by touching a touch sensor with an operator's finger or the like while visually checking content displayed on a display unit.

Patent Literature (PTL) 1 discloses a touch panel board including a mesh electrode made from a metal or the like in a mesh pattern as an electrode for position sensing.

### CITATION LIST

### Patent Literature

PTL 1: Unexamined Japanese Patent Publication No. 2017-126387

### SUMMARY OF THE INVENTION

As indicated in PTL 1, a touch sensor that uses mesh lines as a sensor electrode is susceptible to damage from electrostatic discharge (ESD). Specifically, there is a problem in that a portion at an intersection of the mesh lines burns out due to the electrostatic discharge. As an antistatic measure, an ionizer is used during the manufacturing process, but, there is a problem in that if the ionizer cannot be used, the sensor may break down as a result of the electrostatic discharge induced by electrification.

The present invention allows a reduction in damage to touch sensors from the electrostatic discharge.

A touch sensor according to one aspect of the present invention includes: a substrate having a plurality of edges; a sensor electrode unit disposed on the substrate; and an antistatic electrode unit disposed between the sensor electrode unit and the plurality of edges and including a first needle electrode electrically independent of the sensor electrode unit. A first edge which is one of the plurality of edges is along in a first direction, the first needle electrode is disposed between the first edge and the sensor electrode unit, and the first needle electrode extends toward the first edge.

According to this aspect, autonomous static electricity elimination is carried out using the needle electrode included in the antistatic electrode unit. Thus, the sensor electrode unit can suppress an increase in charging voltage. Accordingly, the sensor electrode unit is less susceptible to damage from the electrostatic discharge.

In the touch sensor according to one aspect of the present invention, the antistatic electrode unit further includes a first base wire disposed between the first edge and the sensor electrode unit, each of a plurality of first needle electrodes is the first needle electrode, and each of the plurality of first needle electrodes projects from the first base wire toward the first edge.

With this configuration, the plurality of needle electrodes allow electrostatic discharge.

In the touch sensor according to one aspect of the present invention, a second edge which is one of the plurality of edges of the substrate is along in a second direction perpendicular to the first direction, the antistatic electrode unit further includes a second base wire and a second needle electrode disposed between the second edge and the sensor electrode unit, each of a plurality of second needle electrodes is the second needle electrode, each of the plurality of second needle electrodes projects from the second base wire toward the second edge, the first base wire extends in the first direction, the second base wire extends in the second direction, the plurality of first needle electrodes extend in the second direction and project from the first base wire toward the first edge, and the plurality of second needle electrode extend in the first direction and project from the second base wire toward the second edge.

With this configuration, the plurality of needle electrodes allow electrostatic discharge in two directions.

Furthermore, in the touch sensor according to one aspect of the present invention, the first base wire and the second base wire are electrically connected to each other.

Furthermore, in the touch sensor according to one aspect of the present invention, each of the plurality of first needle electrodes is thinner at a tip portion than at a portion connected to the first base wire.

Furthermore, in the touch sensor according to one aspect of the present invention, each of the plurality of second needle electrodes is thinner at a tip portion than at a portion connected to the second base wire.

With this, even when the charging voltage is low, an electrical discharge is more likely to occur at the needle electrode.

Furthermore, the touch sensor according to one aspect of the present invention further includes a shield electrode unit which is electrically independent of the sensor electrode unit and at least a portion of which is disposed between the sensor electrode unit and the antistatic electrode unit.

Furthermore, in the touch sensor according to one aspect of the present invention, the antistatic electrode unit is electrically connected to the ground.

With the touch sensor according to the present invention, damage from electrostatic discharge can be reduced using the needle electrodes included in the antistatic electrode unit.

### BRIEF DESCRIPTION OF THE DRAWINGS

FIG. 1 is a perspective view of the entire touch sensor according to the present exemplary embodiment.

FIG. 2 is an exploded perspective view of the touch sensor illustrated in FIG. 1.

FIG. 3 is a schematic view illustrating an example of the arrangement of electrodes on a substrate.

FIG. 4A illustrates the shape of a needle electrode of an antistatic electrode unit.

FIG. 4B illustrates the shape of a needle electrode of an antistatic electrode unit.

FIG. 4C illustrates the shape of a needle electrode of an antistatic electrode unit.

FIG. 5A is a schematic view illustrating another configuration of an antistatic electrode unit.

FIG. 5B is a schematic view illustrating another configuration of an antistatic electrode unit.

### DESCRIPTION OF EMBODIMENTS

### Exemplary Embodiment

Hereinafter, each exemplary embodiment of the present invention will be described in detail with reference to the drawings. The following description of each exemplary embodiment is essentially a mere example and is not intended to limit the present invention, the applicable range thereof, or the usage thereof.

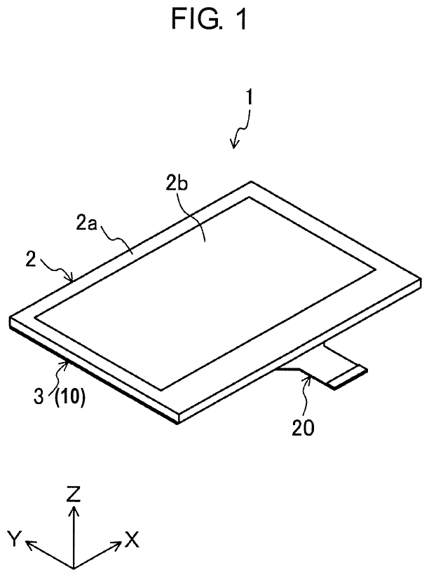

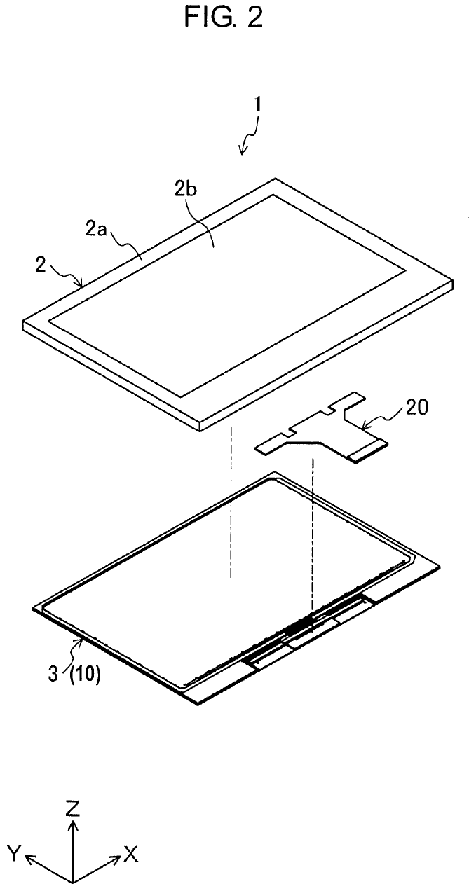

FIG. 1 illustrates the entirety of touch sensor 1 according to the present exemplary embodiment, and FIG. 2 is an exploded view of touch sensor 1 illustrated in FIG. 1. Touch sensor 1 uses an electrostatic capacitive touch-sensor-type input device and functions, for example, as an input device for various devices incorporating display devices such as liquid-crystal displays and organic electroluminescence (EL) displays (for example, in-vehicle devices such as car navigation systems, display devices in personal computers, personal digital assistants, ticket vending machines, and automated teller machines).

As illustrated in FIG. 1 and FIG. 2, touch sensor 1 includes cover member 2, sensor body 3, and flexible wiring board 20.

Note that in the following description, the Z direction is referred to as “up/on/above” and the direction opposite to the Z direction is referred to as “down/under/below” for ease of explanation. Note that terms indicating directions such as “up/on/above”, “down/under/below”, “upper surface”, “lower surface”, “upward”, and “downward” merely indicate relative positioning; thus, these do not limit the present invention.

Cover member 2 is, for example, a cover glass that is made of glass or a cover lens that is made of plastic. Cover member 2 is disposed on sensor body 3. Window frame portion 2a is formed at the periphery of a lower surface of cover member 2. For example, window frame portion 2a has a dark color, such as black, and is formed by being printed substantially in the shape of a frame. Light-transmissive portion 2b which is transparent is formed in window frame portion 2a. Although detailed description is omitted herein, sensor body 3 includes a conductive layer serving as a sensor electrode on a surface of substrate 10; sensor body 3 has a layered structure including substrate 10.

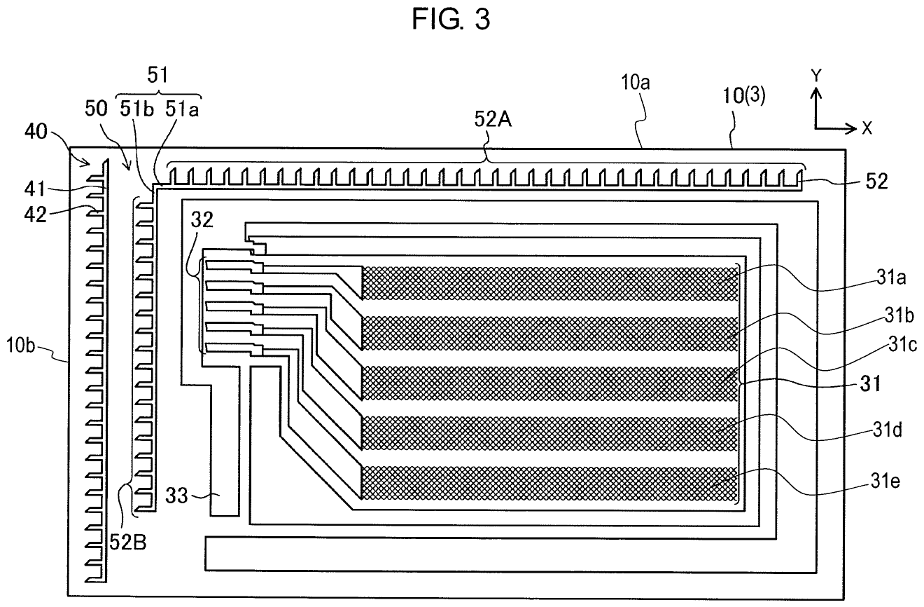

FIG. 3 is a schematic view illustrating an example of the arrangement of electrodes according to the present exemplary embodiment. In the configuration in FIG. 3, sensor electrode unit 31 is formed on substrate 10 included in sensor body 3. Here, sensor electrode unit 31 is formed by arranging thin lines containing a metal such as copper, gold, or silver in a mesh pattern. The width of the metal thin lines is approximately 2 μm. The thickness of the metal thin lines is approximately 1 μm.

In FIG. 3, five electrode areas 31a to 31e which extend in the X direction are arranged in parallel. Each of electrode areas 31a to 31e is formed of metal lines arranged in a mesh pattern. Furthermore, each of electrode areas 31a to 31e is connected to corresponding lead wire 32. Note that in FIG. 3, the shape of sensor electrode unit 31 is schematically illustrated. Thus, the shape of sensor electrode unit 31 is not limited to the shape illustrated in FIG. 3.

Moreover, in the present exemplary embodiment, antistatic electrode units 40, 50 for eliminating static electricity are formed around sensor electrode unit 31. Antistatic electrode unit 40 is formed between edge 10b of substrate 10 and sensor electrode unit 31. Antistatic electrode unit 50 is formed between edge 10a of substrate 10 and sensor electrode unit 31 and between edge 10b of substrate 10 and sensor electrode unit 31. Antistatic electrode units 40, 50 are electrically independent of sensor electrode unit 31. Touch sensor 1 eliminates static electricity though autonomous static electricity elimination that is carried out at antistatic electrode units 40, 50.

Furthermore, shield electrode unit 33 which surrounds sensor electrode unit 31 is disposed on substrate 10. Shield electrode unit 33 is, for example, electrically connected to the ground. In this case, shield electrode unit 33 is provided with a ground potential. At least a portion of shield electrode unit 33 is disposed between sensor electrode unit 31 and antistatic electrode unit 40 or between sensor electrode unit 31 and antistatic electrode unit 50. Furthermore, shield electrode unit 33 is electrically independent of sensor electrode unit 31.

Antistatic electrode unit 40 is formed extending in the Y-direction, in the proximity of the left-hand edge (edge 10b) of substrate 10 in the drawing. Antistatic electrode unit 40 includes base wire 41 and a plurality of needle electrodes 42. Base wire 41 extends in the Y direction. The plurality of needle electrodes 42 project from base wire 41 toward edge 10b of substrate 10.

Antistatic electrode unit 50 includes a portion formed extending in the X direction, in the vicinity of the upper edge (edge 10a) of substrate 10 in the drawing. Furthermore, antistatic electrode unit 50 includes a portion formed extending in the Y direction, between sensor electrode unit 31 and antistatic electrode unit 40. In other words, antistatic electrode unit 50 includes base wire 51 (first base wire 51a and second base wire 51b) and a plurality of needle electrodes 52 (first electrode group 52A and second electrode group 52B).

Base wire 51 includes first base wire 51a extending in the X direction and second base wire 51b extending in the Y direction. Here, first base wire 51a and second base wire 51b are electrically connected. Note that the electrical connection between first base wire 51a and second base wire 51b is not an essential feature.

The plurality of needle electrodes 52 include first electrode group 52A and second electrode group 52B. First electrode group 52A protrudes from first base wire 51a toward an edge of substrate 10 in the Y direction. In other words, each of the plurality of needle electrodes 52 included in first electrode group 52A protrudes from first base wire 51a toward edge 10a of substrate 10.

Second electrode group 52B protrudes from second base wire 51b toward an edge of substrate 10 in the X direction. In other words, each of the plurality of needle electrodes 52 included in second electrode group 52B protrudes from second base wire 51b toward edge 10b of substrate 10.

Here, the autonomous static electricity elimination using the needle electrodes will be described. The autonomous static electricity elimination herein means causing an electric discharge using electrostatic energy in an electrically charged object from which static electricity needs to be eliminated. The electric discharge is likely to occur when a non-uniform electric field is created around a pointed electrode (needle electrode).

A known example of such an electric discharge is a corona discharge or the like. The corona discharge is a phenomenon of an electrical discharge that occurs with light emission around a needle electrode; the more concentrated the electric field created around the needle electrode is, the more likely the corona discharge is to occur.

Thus, even when the charging voltage is low, the corona discharge can occur as long as the electric field is sufficiently concentrated around the needle electrode.

Touch sensor 1 applies such autonomous static electricity elimination by using the needle electrodes. Specifically, as a result of including needle electrode 42 and needle electrode 52, touch sensor 1 can easily cause an electric discharge and thus can suppress an increase in charging voltage at sensor electrode unit 31.

With this, for example, even when the ground potential has not been provided to shield electrode unit 33 during the process of manufacturing touch sensor 1, touch sensor 1 can reduce damage to sensor electrode unit 31 from electrostatic discharge.

Furthermore, even as a final product, it is possible to reduce the occurrence of malfunctions that are caused by triboelectric charging between cover member 2 and an operator's finger, for example.

Note that, for example, upon incorporating touch sensor 1 as an electronic device, the ground for the electronic device and antistatic electrode units 40, 50 of touch sensor 1 may be electrically connected. This allows antistatic electrode units 40, 50 to be used as shield electrodes. Furthermore, antistatic electrode units 40, 50 may be provided with a ground potential to serve as shield electrodes.

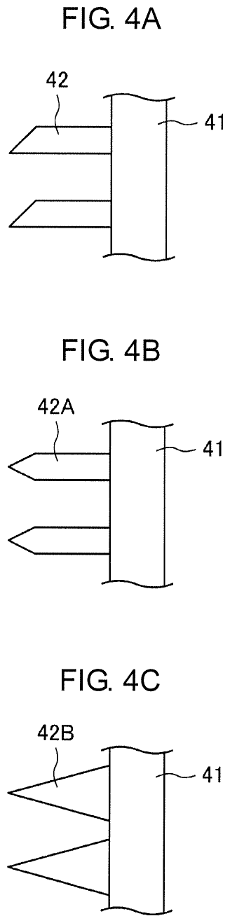

FIG. 4A to FIG. 4C illustrate examples of the shape of the needle electrodes. FIG. 4A to FIG. 4C illustrate examples of the planar shape of needle electrode 42 of antistatic electrode unit 40. FIG. 4A is an expanded view of needle electrode 42 illustrated in FIG. 3 which is in such a shape that a tip portion thereof is cut obliquely with respect to the direction in which needle electrode 42 extends. Needle electrode 42A illustrated in FIG. 4B has a pointed shape with the peak at the center of a tip portion thereof. Needle electrode 42B illustrated in FIG. 4C has a triangular shape. Thus, needle electrodes 42, 42A, 42B are in such a shape that the tip portion is thinner than a portion connected to base wire 41, allowing an electric discharge to more easily occur even when the charging voltage is low.

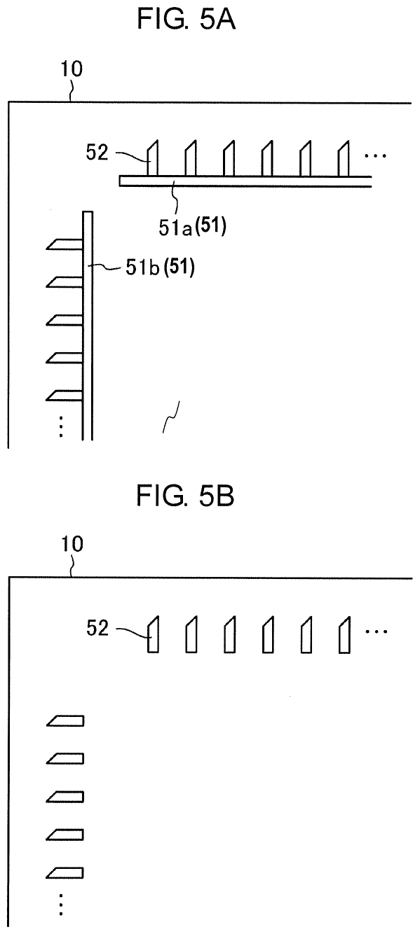

FIG. 5A and FIG. 5B illustrate other configuration examples of antistatic electrode unit 50. In FIG. 5A, first base wire 51a and second base wire 51b included in base wire 51 are physically and electrically separated. In FIG. 5B, base wire 51 (first base wire 51a, second base wire 51b) is omitted, and needle electrodes 52 are arranged along edges of substrate 10. Even with the configurations illustrated in FIG. 5A and FIG. 5B, it is possible to obtain antistatic effects that are substantially the same as those obtained by antistatic electrode unit 50 illustrated in FIG. 3.

As described above, according to the present exemplary embodiment, touch sensor 1 carries out the autonomous static electricity elimination using needle electrodes 42, 52 included in antistatic electrode units 40, 50. This autonomous static electricity elimination occurs, for example, through a corona discharge. Furthermore, by way of this autonomous static electricity elimination, touch sensor 1 can suppress an increase in charging voltage at sensor electrode unit 31. Thus, sensor electrode unit 31 is less likely to be damaged from static electricity.

Note that although sensor electrode unit 31 is formed in a mesh pattern herein, the sensor electrode does not need to be formed in a mesh pattern. Furthermore, although touch sensor 1 is of the electrostatic capacitive type herein, the touch sensor type is not limited to the electrostatic capacitive type. In other words, the present invention is effective in preventing damage to touch sensors from static electricity.

Exemplary embodiments of the present invention have thus far described, but the present invention is not limited to only the above-described exemplary embodiments, and various changes can be made within the scope of the present invention.

### [Outline]

Touch sensor 1 according to the present exemplary embodiment includes: substrate 10 having a plurality of edges (10a, 10b, etc.); sensor electrode unit 31 disposed on substrate 10; and antistatic electrode unit 50 disposed between sensor electrode unit 31 and the plurality of edges (10a, 10b, etc.) and including a needle electrode (42, 52, etc.) electrically independent of sensor electrode unit 31, and, for example, edge 10a which is one of the plurality of edges is along in the X direction, needle electrode 52 is disposed between edge 10a and sensor electrode unit 31, and needle electrode 52 extends toward edge 10a.

In touch sensor 1 according to the present exemplary embodiment, for example, antistatic electrode unit 50 may further include first base wire 51a disposed between edge 10a and sensor electrode unit 31, a plurality of needle electrodes 52 may be disposed, and each of the plurality of needle electrodes 52 in first electrode group 52A may project from first base wire 51a toward edge 10a.

In touch sensor 1 according to the present exemplary embodiment, for example, edge 10b which is one of the plurality of edges (10a, 10b, etc.) of substrate 10 extends in the Y direction perpendicular to the X direction, antistatic electrode unit 50 further includes a base wire (41, 51b, etc.) and a needle electrode (42, 52, etc.) disposed between edge 10b and sensor electrode unit 31, a plurality of needle electrodes (the plurality of needle electrodes 42, second electrode group 52B, etc.) are disposed, and each of the plurality of needle electrodes projects from the base wire (41, 51b, etc.) toward edge 10b. First base wire 51a may extend in the X direction, base wire 41 and second base wire 51b may extend in the Y direction, the plurality of needle electrodes 52 in first electrode group 52A may extend in the Y direction and protrude from first base wire 51a toward edge 10a, the plurality of needle electrodes (the plurality of needle electrodes 42, second electrode group 52B, etc.) may extend in the X direction and project from the base wire (base wire 41, second base wire 51b, etc.) toward edge 10b.

First base wire 51a and second base wire 51b may be electrically connected to each other.

Each of the plurality of needle electrodes (first electrode group 52A) may be thinner at a tip portion than at a portion connected to first base wire 51a.

Each of the plurality of needle electrodes (the plurality of needle electrodes 42, second electrode group 52B) may be thinner at a tip portion than at a portion connected to the second base wire (41, 51b).

Touch sensor 1 may further include shield electrode unit 33 which is electrically independent of sensor electrode unit 31 and at least a portion of which is disposed between sensor electrode unit 31 and antistatic electrode unit 50.

Antistatic electrode unit 50 may be electrically connected to the ground.

### INDUSTRIAL APPLICABILITY

The touch sensor according to the present invention can reduce damage from static electricity and thus is useful, for example, for reducing the manufacturing cost of a touch-sensor-type input device and preventing malfunctions thereof.

### REFERENCE MARKS IN THE DRAWINGS

1 touch sensor
2 cover member
2a window frame portion
2b light-transmissive portion
3 sensor body
10 substrate
10a, 10b edge
20 flexible wiring board
31 sensor electrode unit
31a-31d electrode area
32 lead wire
33 shield electrode unit
40 antistatic electrode unit
41 base wire
42, 42A, 42B needle electrode
50 antistatic electrode unit
51 base wire
51a first base wire
51b second base wire
52 needle electrode
52A first electrode group
52B second electrode group

1. A touch sensor, comprising:
a substrate having a plurality of edges;
a sensor electrode unit disposed on the substrate; and
an antistatic electrode unit disposed between the sensor electrode unit and the plurality of edges, the antistatic electrode unit including a first needle electrode electrically independent of the sensor electrode unit, wherein
a first edge which is one of the plurality of edges is along in a first direction,
the first needle electrode is disposed between the first edge and the sensor electrode unit, and
the first needle electrode extends toward the first edge.

2. The touch sensor according to claim 1, wherein
the antistatic electrode unit further includes a first base wire disposed between the first edge and the sensor electrode unit,
each of a plurality of first needle electrodes is the first needle electrode, and
each of the plurality of first needle electrodes projects from the first base wire toward the first edge.

3. The touch sensor according to claim 2, wherein
a second edge which is one of the plurality of edges of the substrate is along in a second direction perpendicular to the first direction,
the antistatic electrode unit further includes a second base wire and a second needle electrode disposed between the second edge and the sensor electrode unit,
each of a plurality of second needle electrodes is the second needle electrode,
each of the plurality of second needle electrodes projects from the second base wire toward the second edge,
the first base wire extends in the first direction,
the second base wire extends in the second direction,
the plurality of first needle electrodes extend in the second direction and project from the first base wire toward the first edge, and
the plurality of second needle electrodes extend in the first direction and project from the second base wire toward the second edge.

4. The touch sensor according to claim 3, wherein
the first base wire and the second base wire are electrically connected to each other.

5. The touch sensor according to claim 2, wherein
each of the plurality of first needle electrodes is thinner at a tip portion than at a portion connected to the first base wire.

6. The touch sensor according to claim 3, wherein
each of the plurality of second needle electrodes is thinner at a tip portion than at a portion connected to the second base wire.

7. The touch sensor according to claim 1, further comprising:
a shield electrode unit, at least a portion of which is disposed between the sensor electrode unit and the antistatic electrode unit, the shield electrode unit being electrically independent of the sensor electrode unit.

8. The touch sensor according to claim 1, wherein
the antistatic electrode unit is electrically connected to ground.
